(19) United States
(12) Patent Application Publication
(10) Pub. No.: US 2015/0251951 A1
(43) Pub. Date: Sep. 10, 2015

(54) Production Bricks from Mine Tailings Through Geopolymerization

(71) Applicant: ARIZONA BOARD OF REGENTS ON BEHALF OF THE UNIVERSITY OF ARIZONA, Tucson, AZ (US)

(72) Inventors: Lianyang Zhang, Tucson, AZ (US); Saeed Ahmari, Tucson, AZ (US); Jinhong Zhang, Tucson, AZ (US)

(21) Appl. No.: 14/432,971

(22) PCT Filed: Oct. 1, 2013
(86) PCT No.: PCT/US13/62922

§ 371 Date: Apr. 1, 2015

Related U.S. Application Data
(60) Provisional application No. 61/744,658, filed on Oct. 1, 2012.

(51) Int. Cl. C04B 18/12

(52) U.S. Cl. CPC C04B 18/12

(57) ABSTRACT

Methods for utilizing copper mine tailings for production of eco-friendly bricks based on the geopolymerization technology and bricks so produced (FIG. 6). The procedure for producing the bricks includes mixing the tailings with an alkaline solution, forming the brick by compressing the mixture within a mold under a specified pressure, and curing the brick at a slightly elevated temperature. Unlike the conventional method for producing bricks, the new procedure neither uses clay and shale nor requires high temperature kiln firing, having significant environmental and ecological benefits.

### CROSS-REFERENCE TO RELATED APPLICATIONS

This application claims the benefit of and priority from U.S. Provisional Patent Application No. 61/744,658, filed on Oct. 1, 2012 and titled “Production Bricks From Mine Tailings Through Geopolymerization.” The disclosure of the above-identified patent application is hereby incorporated by reference for all purposes.

### STATEMENT OF GOVERNMENT RIGHTS

This invention was made with government support under Grant No. 0969385 awarded by the National Science Foundation. The government has certain rights in the invention.

### TECHNICAL FIELD

This invention relates to utilization of mine tailings for production of useful items such as bricks based on geopolymerization technology.

### BACKGROUND

Bricks are a widely used construction and building material. For example, in the United States, about 9 billion bricks are used a year [1,2]. Conventional production of bricks usually utilizes clay and shale as the source material and requires high temperature (900-1,000° C.) kiln firing. Quarrying operations for producing the clay and shale are energy intensive, adversely affect the landscape, and can release high level of waste materials. The high temperature kiln firing not only consumes significant amount of energy, but also releases substantial quantity of greenhouse gases. It is also noted that there is a shortage of clay and shale in many parts of the world. To protect the clay and shale resource and protect the environment, some countries such as China have started to limit the use of bricks made from clay and shale [3,4].

Researchers have studied the utilization of different types of wastes to produce construction and building bricks [4-10]. Chen et al. [4] studied the feasibility of utilizing hematite tailings together with clay and Class F fly ash to produce bricks and found that the percentage of tailings used could be up to 84% of the total weight. Based on the test results, they recommended a tailings:clay:fly ash ratio of 84:10:6, with a forming water content of 12.5-15%, a forming pressure of 20-25 MPa, and a firing temperature of 980-1,030° C. for 2 hours, to produce good quality bricks. Chou et al. [5] investigated the utilization of Class F fly ash to replace part of the clay and shale in production of bricks using the conventional procedure. Bricks with up to 40% of fly ash were successfully produced in commercial-scale production test runs, with the properties exceeding the ASTM commercial specifications. Morchhale et al. [6] studied the production of bricks by mixing copper mine tailings with different amount of ordinary Portland cement (OPC) and then compressing the mixture in a mold. The results show that the bricks have higher compressive strength and lower water absorption when the OPC content increases. Roy et al. [7] used gold mill tailings to make bricks by mixing them with OPC, black cotton soils or red soils. The OPC-tailings bricks were just cured by immersing them in water but the soil-tailings bricks were sun-dried and then fired at high temperatures (750, 850, and 950° C.). Liu et al. [8] explored the feasibility of using the sludge derived from dyestuff-making wastewater coagulation for producing unfired bricks. They tried four typical cements, OPC, ground clinker of silicate cement, alumina cement, and slag cement, as the binder. The experimental results showed that the cement solidified sludge could meet all performance criteria for unfired bricks at a cement/dry sludge/water ratio of 1:0.5-0.8:0.5-0.8. The compressive strength of alumina cement solidified sludge was the highest and exceeded 40 MPa. Algin and Turgut [9] tried to use cotton wastes (CW) and limestone powder wastes together with OPC to produce bricks and found that the amount of CW used affect both the density and the mechanical properties of bricks. Bricks with 30% of CW had a compressive strength of 7 MPa and a flexural strength of 2.2 MPa. Shon et al. [10] studied the use of stockpiled circulating fluidized bed combustion ash (SCFBCA) with Type I cement, lime, Class F fly ash, and/or calcium chloride to manufacture compressed bricks. They used a compaction pressure of 55.2 MPa and placed the specimens at 23° C. and 100% relative humidity room for 1 day before air curing at room temperature.

It is noted that these different methods for utilizing wastes to make bricks either require high temperature kiln firing or use cement as the binder. Therefore, they still have the drawbacks of high-energy consumption and large quantity of greenhouse gas emissions.

### SUMMARY

This disclosure relates to methods for utilizing mine tailings for production of eco-friendly bricks based on the geopolymerization technology and bricks so produced. The procedure for producing the bricks includes mixing the tailings with an alkaline solution, forming the brick by compressing the mixture within a mold under a specified pressure, and curing the brick at a slightly elevated temperature.

Copper mine tailings have been found to be especially useful in the methods described herein.

Other features and advantages of the invention will be apparent from the following detailed description and figures, and from the claims.

### BRIEF DESCRIPTION OF THE FIGURES

FIG. 1 shows the particle size distribution of mine tailings.

FIG. 2 depicts the XRD pattern of un-reacted mine tailings (A: albite, G: gypsum, P: sanidine, S: quartz).

FIG. 3 features the load-displacement curves at forming stage for different initial water contents and forming pressures.

FIG. 4 illustrates the UCS vs. curing temperature for specimens prepared at 12% initial water content, 25 MPa forming pressure, and respectively 10 and 15 M NaOH concentrations.

FIG. 5 depicts the UCS vs. forming pressure for specimens prepared at different initial water contents and 15 M NaOH concentration and cured for 7 days at 90° C.

FIG. 6 compares the initial water contents and optimum forming pressures used in the current study and by other researchers.

FIG. 7 shows a SEM micrographs of MT powder—a) and b), geopolymer brick at initial water content/forming pressure combinations of 12%/25 MPa—c) and d), and 16%/0.5 MPa—e) and f), for the specimens cured at 90° C. for 7 days (GP: geopolymer, MT: mine tailings particle).

FIG. 8 depicts XRD patterns: a) mine tailings powder and geopolymer brick specimens prepared at initial water content/forming pressure respectively of 12%/25 MPa and 16%/0.5 MPa, and cured at 90° C. for 7 days; and b) differential XRD between the two brick specimens (A: albite, G: gypsum, P: sanidine, S: quartz).

FIG. 9 illustrates UCS vs. final water content for specimens prepared at 15 M NaOH and different forming pressures and cured for 7 days at 90° C.

FIG. 10 is a comparison of water absorption versus soaking time for specimens prepared at 16% initial water content and different forming pressures and cured at 90° C. for 7 days.

FIG. 11 depicts bulk unit weight versus forming pressure for specimens prepared at different initial water contents and 15 M NaOH and cured at 90° C. for 7 days.

### DETAILED DESCRIPTION

Recently, researchers have started to use the geopolymerization technology to produce bricks from wastes. Geopolymerization is the reaction undergone by aluminosilicates in a highly concentrated alkali hydroxide or silicate solution, forming a very stable material called geopolymer having amorphous polymeric structures with interconnected Si—O—Al—O—Si bonds [11-17]. According to Duxson et al. [13] and Dimas et al. [14], the geopolymerization process includes dissolution of solid aluminosilicate materials in a strong alkaline solution, formation of silica-alumina oligomers, polycondensation of the oligomeric species to form inorganic polymeric material, and bonding of un-dissolved solid particles in the final geopolymeric structure.

Geopolymer not only provides performance comparable to OPC in many applications, but shows additional advantages such as rapid development of mechanical strength, high acid resistance, no/low alkali-silica reaction (ASR) related expansion, excellent adherence to aggregates, immobilization of toxic and hazardous materials, and significantly reduced greenhouse gas emissions [11-13,18-20]. Freidin [21] used geopolymerization of Class F fly ash (FA) or a combination of FA and bottom ash (BA) to produce cementless bricks. He used water glass with a silica module of 2.3 as the alkali activator and applied different forming pressures to prepare the test specimens. The results showed that the cementless bricks based on geopolymerization could meet the requirements of Israeli Standard for conventional cement concrete blocks. Diop and Grutzeck [22] investigated the feasibility of utilizing an aluminosilicate-rich tuff to produce bricks based on the geopolymerization technology. They used sodium hydroxide (NaOH) solution as the alkali activator and prepared the test specimens by compressing the tuff-NaOH solution mixture in a cylinder with a pressure of about 10 MPa. They studied the effect of both the NaOH concentration (4, 8, and 12 M) and the curing temperature (40, 80, and 120° C.). The results showed that the strength increases with the NaOH concentration and the curing temperature.

Mohsen and Mostafa [23] studied the utilization of low kaolinitic clays (white clay, grey clay, and red clay) to produce geopolymer bricks. The clay raw materials were activated by calcination at 700° C. for 2 hours and ground in an alumina ball mill and sieved to <120 μm before being used. Both NaOH solution and NaOH+sodium silicate solution were used as the alkali activator. The test specimens were molded using a forming pressure of 15 MPa in a special steel mold. The molded specimens were allowed to mature at room temperature for 24 hours and then cured at different temperature for different time (room temperature for 3 days, 75° C. for 24 hours, or 150° C. for 24 hours) before being tested. The results showed that the type of alkali activator and the curing temperature are two major factors affecting the behavior of geopolymer bricks. With the right alkali activator and the appropriate curing temperature, all of the three studied low kaolinitic clays are suitable for producing geopolymer bricks.

Considering the fact that a large amount of copper mine tailings are generated each year [24-26] and that copper mine tailings are rich in silica and alumina and can be used as a potential source material for production of geopolymers [19,27-30], this disclosure describes the feasibility of utilizing copper mine tailings to produce eco-friendly geopolymer bricks. The geopolymer bricks are produced by mixing the tailings with an alkaline solution, forming the brick by compressing the mixture within a mold under a specified pressure, and curing the brick at a slightly elevated temperature. Unlike the conventional method for producing bricks, the new procedures neither use clay and shale nor requires high temperature kiln firing, thus having significant environmental and ecological benefits. Moreover, the methods described herein are expected to be applicable to other types of tailings as long as they contain suitable amount of silica and alumina such that geopolymerization occurs.

### NON-LIMITING EXAMPLES

### 1. Experimental Details

### 2.1. Materials

The materials used in this example include copper mine tailings (MT), reagent grade 98% sodium hydroxide (NaOH), and de-ionized water. The mine tailings were received in the form of dry powder from Mission Mine Operations of ASARCO LLC in Tucson, Ariz. Table 1 shows the chemical composition of the mine tailings.

TABLE 1
Chemical composition of mine tailings.

| Chemical Compound | Weight % |
|---|---|
| SiO₂ | 64.8 |
| Al₂O₃ | 7.08 |
| Fe₂O₃ | 4.33 |
| CaO | 7.52 |
| MgO | 4.06 |
| SO₃ | 1.66 |
| Na₂O | 0.90 |
| K₂O | 3.26 |

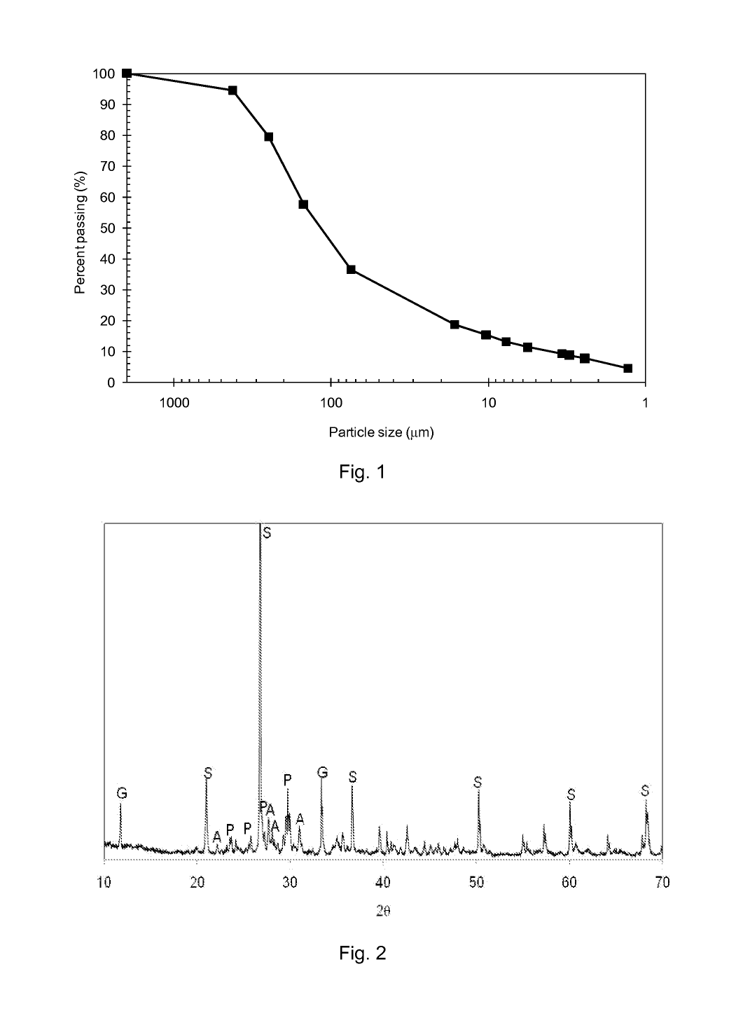

It can be seen that the mine tailings consist mainly of silica and alumina with substantial amount of calcium and iron. Grain size distribution analysis was performed on the mine tailings using mechanical sieving and hydrometer analysis following ASTM D6913 and ASTM D422. FIG. 1 shows the particle size distribution curve. The mean particle size is around 120 μm with 36% particles passing No. 200 (75 μm) sieve. The specific gravity of the MT particles is 2.83. The XRD pattern of the mine tailings powder is shown in FIG. 2. The mine tailings are mainly crystalline materials consisting of quartz (SiO₂) as the main constituent, albite (NaAlSi₃O₈), sanidine (K,Na)(Si,Al)₄O₈, and gypsum (CaSO₄.2H₂O).

The sodium hydroxide (NaOH) flakes were obtained from Alfa Aesar Company in Ward Hill, Mass. The sodium hydroxide solution is prepared by dissolving the sodium hydroxide flakes in de-ionized water.

### 2.2. Preparation of Geopolymer Brick Samples

First, the mine tailings were mixed with sodium hydroxide solution. The sodium hydroxide solution was prepared by adding sodium hydroxide flakes to de-ionized water and stirring for at least five minutes. Due to the generated heat, enough time was allowed for the solution to cool down to room temperature before it was used. The amount/weight of NaOH added to the tailings is determined based on the concentration of the NaOH solution and the weight percentage of water relative to tailings. For example, consider a concentration of 15M NaOH and a tailings water content of 16%. If the dry weight of mine tailings are 1000 g, then the weight of water will be 1000×16%=160 g, which is 0.16 L and the dry weight of NaOH is 15×40×0.16=96 g.

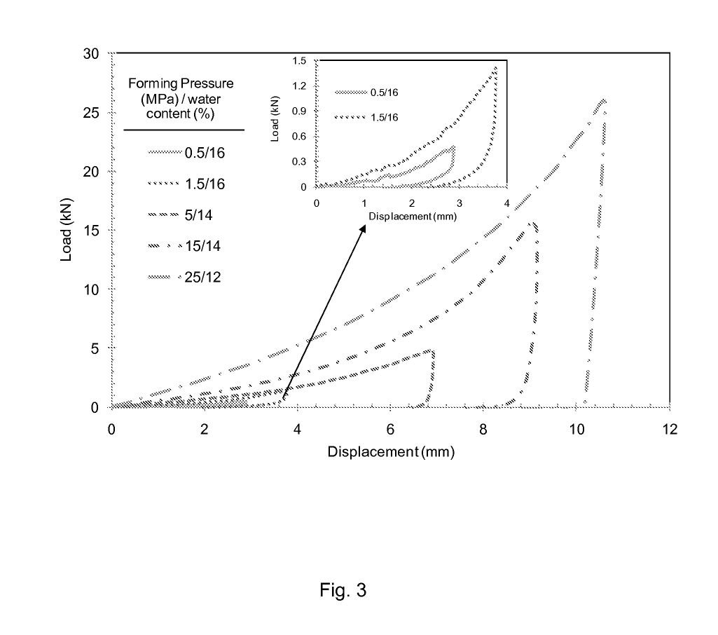

The NaOH solution was slowly added to the dry mine tailings and mixed for 10 minutes to ensure the homogeneity of the mixture. The generated mine tailings and NaOH solution mixture exhibits varying consistency depending on the initial water content. The mixture's consistency varies from semi-dry to semi-paste as the water content changes from 8% to 18%. The mixture was placed in the Harvard Miniature Compaction cylindrical molds of 33.4 mm diameter and 72.5 mm height with minor compaction. The compacted specimens were then compressed with a Geotest compression machine at different loading rates to ensure that the duration of forming pressure was about 10 minutes for all the specimens. FIG. 3 shows the typical load-displacement curves for different forming pressures. At low forming pressures and high water contents substantial amount of elastic deformations can be seen. At high forming pressures and low water contents, however, the elastic deformation seems negligible indicating that the occurred deformations are mainly plastic, which leads to volume decrease of voids within the granular matrix. After the compression, the specimens were de-molded and placed uncovered in an oven for curing at a specified temperature for 7 days before being tested. The specimens were weighed before and after the curing to measure the final water content.

### 2.3. Methodology

Unconfined compression tests were performed to measure the 7 days' unconfined compressive strength (UCS) of geopolymer bricks produced at different conditions. The effects of NaOH concentration, curing temperature, water content, and forming pressure on the UCS were investigated. Specimens were prepared at two NaOH concentrations of 10 and 15 M, curing temperature ranging from 60 to 120° C., water content from 8 to 18%, and forming pressure from 0 to 35 MPa. Water content indicates the mass ratio between the water in the activating solution and the solid part of the mixture. The mass ratio between the activator, NaOH, and MT varies from 4.8 to 10.8% depending on the NaOH concentration and water content. For each condition, at least three specimens were tested and the average of the measured UCS values was used. Totally, about 150 tests were performed for the UCS measurements. The cylindrical specimens were polished at the end surfaces to ensure that they are accurately flat and parallel. The Geotest loading machine was used for the compression test at a constant loading rate of 0.1 mm/min.

Water absorption tests were conducted according to ASTM C67-07 [31] to study the capability of specimens in absorbing water, which depends on the microstructure and porosity of the specimens. Besides that, water absorption can be an indicator of the degree of geopolymeric reaction. The geopolymer brick specimens prepared at 16% initial water content, 15 M NaOH concentration, and different forming pressures and cured at 90° C. for 7 days were soaked in water and weighed every 24 hours for 6 days. 5 specimens were tested for each forming pressure and the average was used for the plot. Before weighing the soaked specimens, the wet surface was dried with a damp cloth. The percentage absorption was calculated as follows

Absorption(%)=[(W₂−W₁)/W₁]×100 (1)

where W₁=weight of specimen after complete drying at 105° C., and W₂=weight of specimen after soaking.

To investigate the effect of moisture content and forming pressure on the microstructure and phase composition of the geopolymer bricks, SEM imaging and XRD analysis were also performed. The SEM imaging of geopolymer specimens was performed in the SE conventional mode using the FEI INSPEC-S50/Thermo-Fisher Noran 6 microscope. The freshly failed surfaces from the unconfined compression tests, without polishing to keep the fractured surface “un-contaminated”, were used for the SEM imaging. The XRD analysis was performed with a Scintag XDS 2000 PTS diffractometer using Cu Kα radiation, at 2.00 degree/min ranging from 10.00 to 70.00 degrees with 0.600 second count time.

Table 2 summarizes the tests conducted on the brick specimens at different conditions.

TABLE 2
Specimen properties and different types of tests conducted.

| | NaOH | Water | Forming | NaOH/ | | | Curing | | | | |
|---|---|---|---|---|---|---|---|---|---|---|---|
| | Conc. | content | Pressure | MT | | | Temp. | UCS | Absorption | | |
| Specimen Label | (M) | (%) | (MPa) | (%) | Na/Al | Na/Si | (° C.) | Test | Test | XRD | SEM |
| 10-12-25-60 | 10 | 12 | 25 | 4.8 | 0.86 | 0.11 | 60 | X | | | |
| 10-12-25-90 | 10 | 12 | 25 | 4.8 | 0.86 | 0.11 | 90 | X | | | |
| 10-12-25-120 | 10 | 12 | 25 | 4.8 | 0.86 | 0.11 | 120 | X | | | |
| 15-12-25-60 | 15 | 12 | 25 | 7.2 | 1.30 | 0.17 | 60 | X | | | |
| 15-12-25-75 | 15 | 12 | 25 | 7.2 | 1.30 | 0.17 | 75 | X | | | |
| 15-12-25-90 | 15 | 12 | 25 | 7.2 | 1.30 | 0.17 | 90 | X | | X | X |
| 15-12-25-105 | 15 | 12 | 25 | 7.2 | 1.30 | 0.17 | 105 | X | | | |
| 15-12-25-120 | 15 | 12 | 25 | 7.2 | 1.30 | 0.17 | 120 | X | | | |
| 15-8-5-90 | 15 | 8 | 5 | 4.8 | 0.86 | 0.11 | 90 | X | | | |
| 15-8-15-90 | 15 | 8 | 15 | 4.8 | 0.86 | 0.11 | 90 | X | | | |
| 15-8-25-90 | 15 | 8 | 25 | 4.8 | 0.86 | 0.11 | 90 | X | | | |
| 15-8-35-90 | 15 | 8 | 35 | 4.8 | 0.86 | 0.11 | 90 | X | | | |
| 15-10-5-90 | 15 | 10 | 5 | 6 | 1.08 | 0.14 | 90 | X | | | |
| 15-10-15-90 | 15 | 10 | 15 | 6 | 1.08 | 0.14 | 90 | X | | | |
| 15-10-25-90 | 15 | 10 | 25 | 6 | 1.08 | 0.14 | 90 | X | | | |
| 15-10-35-90 | 15 | 10 | 35 | 6 | 1.08 | 0.14 | 90 | X | | | |
| 15-12-5-90 | 15 | 12 | 5 | 7.2 | 1.30 | 0.17 | 90 | X | | | |
| 15-12-15-90 | 15 | 12 | 15 | 7.2 | 1.30 | 0.17 | 90 | X | | | |
| 15-12-35-90 | 15 | 12 | 35 | 7.2 | 1.30 | 0.17 | 90 | X | | | |
| 15-14-5-90 | 15 | 14 | 5 | 8.4 | 1.51 | 0.19 | 90 | X | | | |
| 15-14-10-90 | 15 | 14 | 10 | 8.4 | 1.51 | 0.19 | 90 | X | | | |
| 15-14-15-90 | 15 | 14 | 15 | 8.4 | 1.51 | 0.19 | 90 | X | | | |
| 15-14-25-90 | 15 | 14 | 25 | 8.4 | 1.51 | 0.19 | 90 | X | | | |
| 15-16-0-90 | 15 | 16 | 0 | 9.6 | 1.73 | 0.22 | 90 | X | | | |
| 15-16-05-90 | 15 | 16 | 0.5 | 9.6 | 1.73 | 0.22 | 90 | X | X | X | X |
| 15-16-105-90 | 15 | 16 | 1.5 | 9.6 | 1.73 | 0.22 | 90 | X | X | | |
| 15-16-3-90 | 15 | 16 | 3 | 9.6 | 1.73 | 0.22 | 90 | X | X | | |
| 15-16-5-90 | 15 | 16 | 5 | 9.6 | 1.73 | 0.22 | 90 | X | X | | |
| 15-16-15-90 | 15 | 16 | 15 | 9.6 | 1.73 | 0.22 | 90 | X | X | | |
| 15-18-0-90 | 15 | 18 | 0 | 9.6 | 1.94 | 0.22 | 90 | X | | | |
| 15-18-02-90 | 15 | 18 | 0.2 | 10.8 | 1.94 | 0.25 | 90 | X | | | |
| 15-18-04-90 | 15 | 18 | 0.4 | 10.8 | 1.94 | 0.25 | 90 | X | | | |
| 15-18-05-90 | 15 | 18 | 0.5 | 10.8 | 1.94 | 0.25 | 90 | X | | | |
| 15-18-105-90 | 15 | 18 | 1.5 | 10.8 | 1.94 | 0.25 | 90 | X | | | |

### Results and Discussion

### 3.1. UCS

### 3.1.1. Effect of Curing Temperature and NaOH Concentration

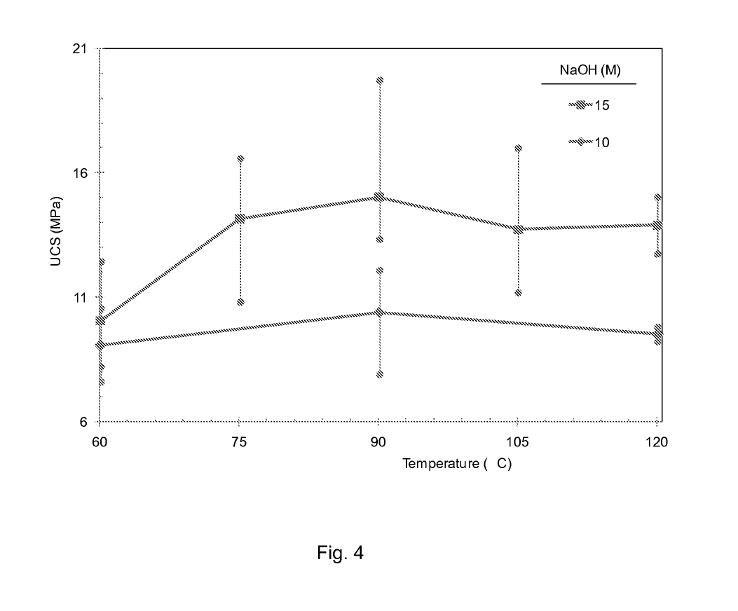

FIG. 4 shows the variation of UCS with curing temperature for specimens prepared at 12% initial water content, 25 MPa forming pressure, and respectively at 10 and 15 M NaOH concentrations. At both 10 and 15 M NaOH, UCS increases with the curing temperature up to about 90° C. and then decreases. While not limiting the embodiments herein to a particular theory or mechanism of action, the change of UCS with curing temperature can be explained by the underlying mechanism in geopolymerization.

As stated earlier, dissolution and polycondensation are the two main steps in geopolymerization. Increasing the curing temperature helps accelerate the dissolution of silica and alumina species and then polycondensation. However, when the temperature is above a certain level, the fast polycondensation and rapid formation of geopolymeric gel will hinder further dissolution of silica and alumina species and thus affect the strength adversely [32,33]. Besides that, since the brick specimens are cured in the oven without any coverage, too high a temperature causes fast evaporation of water and may lead to incomplete geopolymerization. A similar relationship between UCS and curing temperature is also reported by other researchers [22,23,34]. Diop and Grutzeck [22] tested tuff-based geopolymer bricks and came up with 40° C. and 80° C. as the optimum temperatures, respectively for 8-12 M and 4 M NaOH concentrations. Mohsen and Mostafa [23] studied the curing temperature effect on calcined clay-based geopolymer bricks and reported an optimum temperature of 75° C. Arioz et al. [34] tested fly ash-based geopolymer bricks cured between 40 and 100° C. and obtained the highest UCS at about 60° C.

The UCS at 15 M NaOH is higher than that at 10 M NaOH for all curing temperatures considered, which can be simply explained by the fact that at higher NaOH concentration, higher NaOH/MT ratio and consequently higher Na/Al and Na/Si ratios were obtained (see Table 2). The higher Na/Al and Na/Si ratios indicate that a larger amount of Na⁺ cation is available to dissolve silica and alumina and consequently thicker geopolymeric binder is produced. The geopolymeric binder serves as a link between the un-reacted or partially reacted particles and contributes directly to the strength of the geopolymer material. The improving effect of alkalinity on geopolymerization is reported by a number of researchers [35-38]. In particular, Wang et al. [37] studied the effect of NaOH concentration on metakaolin-based geopolymer specimens prepared at a water content of about 30% and a forming pressure of 4 MPa. The results show that when the NaOH concentration was increased from 4 to 12 M, higher UCS, flexural strength, and apparent density were obtained.

### 3.1.2. Effect of Water Content and Forming Pressure

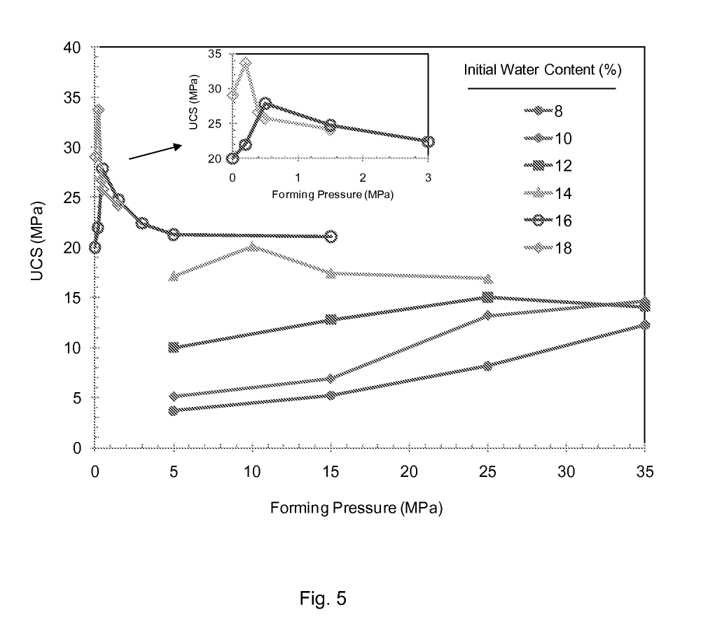

Considering the effect of curing temperature and NaOH concentration on UCS as discussed in the previous subsection, 90° C. and 15 M NaOH were selected to study the effects of water content and forming pressure. FIG. 5 shows the unconfined compression test results at different initial water contents and forming pressures. Higher initial water content, which means higher amount of NaOH (or higher NaOH/MT ratio) at constant NaOH concentration, results in higher UCS. The highest UCS of 33.7 MPa was obtained at 18% initial water content and 0.2 MPa forming pressure. The increase of UCS with the initial water content may be explained from two aspects.

First, water itself acts as a medium for the geopolymeric reaction. After dissolution, the liberated monomers diffuse in the liquid medium and form oligomers. It is important that sufficient amount of water is available for the formation of geopolymeric binder linking the un-reacted or partially reacted particles. However, too much water will cause the formation of large pores, which weakens the geopolymeric specimens. Too high a water content may also adversely affect the brick forming process. The forming pressure causes the MT particles to rearrange to a denser configuration by pushing the air out of the matrix. This leads to a degree of saturation close to 100% when the forming pressure is sufficiently high. At higher water content, the saturation state will be achieved at a lower pressure and a less dense structure will be obtained. Further increase in forming pressure will lead to squeezing out of water from the matrix.

The other aspect is related to the availability of sufficient amount of NaOH in the liquid phase for geopolymerization. The availability of the activating agent (or NaOH/MT) can be expressed in two different ratios, Na/Al and Na/Si, to differentiate the role of the activating agent in dissolving Al and Si. Higher Na/Al ratio leads to dissolution of more Al and therefore sufficient amount of Na⁺ cation must be available for charge balancing the alumina ions. For charge balancing, the Na/Al ratio has to be in a certain range. To produce geopolymer concrete, different Na/Al ratios ranging from 0.38 to 2.06 have been used by researchers [15,32,35,39-42]. Zhang et al. [30] showed that for geopolymerization of fly ash added mine tailings, the increase in the Na/Al ratio up to 2.0 results in higher UCS. In the current experiment, the Na/Al ratios vary from 0.86 to 1.94 corresponding to the 8% to 18% initial water contents (see Table 2). By increasing the initial water content at a constant NaOH concentration, the Na/Al ratio increases and thus higher strength apparently resulted.

Increased Na/Si ratio due to the increase of NaOH is another reason for the improving effect of water content. In addition to Al, NaOH also acts as a dissolving agent for Si. Increasing water content at constant NaOH concentration requires more NaOH, which results in dissolution of more Si. The amorphous phase of MT is the primary source of Si and Al species; however, the crystalline phase is also likely to provide additional Si and Al. The Si source in the crystalline phase can be quartz, albite, and sanidine while the Al source is albite and sanidine. Since Si is harder than Al to dissolve and quartz is more stable than the other minerals, increasing alkalinity may help incorporate more Si in geopolymerization. The Na/Si ratio varies between 0.11 and 0.25 corresponding to water content of 8 to 18% (see Table 2).

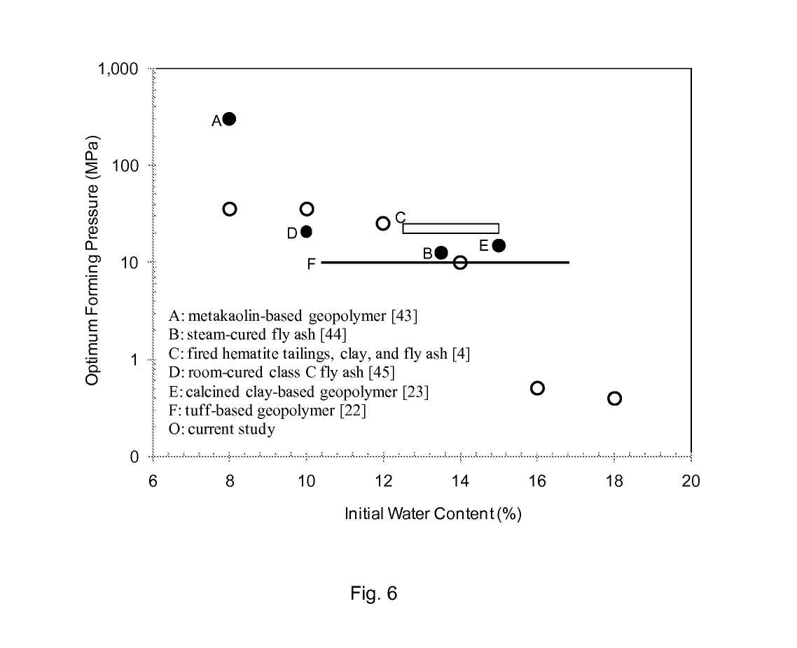

The forming pressure has an improving effect on UCS but only up to a certain level. FIG. 5 shows that when the initial water content is 10% or lower, UCS tends to increase with the forming pressure. However, when the initial water content is higher than 10%, UCS increases with the forming pressure up to a certain level and then decreases. This can be explained by the counteracting effect of water content and forming pressure at high water content levels. When the initial water content is low, higher forming pressure leads to higher degree of compaction of the specimen but no NaOH solution is squeezed out from the specimen during the forming process. The sole compaction effect leads to increase of UCS with higher forming pressure. When the initial water content is high, however, the NaOH solution will be squeezed out from the specimen after the forming pressure exceeds a certain limit. As sated earlier, the amount of NaOH solution (or MT/NaOH ratio) affects the degree of geopolymerization and thus the strength of the geopolymer specimen. The loss of NaOH solution due to the higher forming pressure will lead the decrease of UCS. So, at high initial water content, the combined effects of compaction and NaOH solution loss due to the forming pressure will control the final strength of the geopolymer specimen. FIG. 5 shows that the highest UCS is obtained at 25, 10, 0.5, and 0.2 MPa forming pressure respectively for the initial water content of 12, 14, 16, and 18%. FIG. 6 shows the initial water content and forming pressure used by different researchers. In general, the forming pressure is related to the initial water content, higher forming pressure corresponding to lower initial water content. At the lowest initial water content of 8%, a very high forming pressure of 300 MPa is used [43].

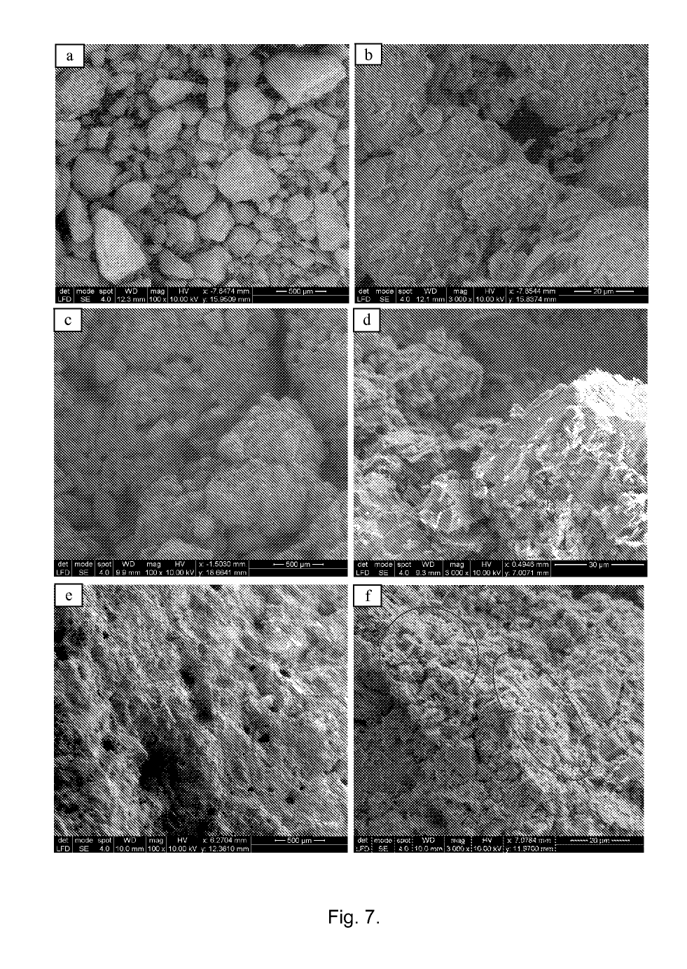

SEM imaging and XRD analysis were also performed to further investigate the effect of initial water content and forming pressure on the microstructure and phase composition of the geopolymer brick specimens. Two initial water content/forming pressure combinations, 12%/25 MPa and 16%/0.5 MPa, were selected for the comparison. FIG. 7 shows the SEM micrographs of the original MT and the geopolymer brick at both low and high magnifications. The original MT particles have irregular shapes and the fine particles are attached to each other and to the surface of the coarse particles (see FIGS. 7a and b). As can be seen in the micrographs of the geopolymer brick at low magnifications, at the lower initial water content, the particles and particle aggregates are more isolated with large voids and gaps (see FIG. 7c) while at the higher initial water content, the distribution of particles and particle aggregates is more pervasive with only tiny voids (see FIG. 7e). The micrographs at higher magnifications clearly indicate the degree of geopolymerization affected by the initial water content. At the lower initial water content, which means lower NaOH amount (or NaOH/MT ratio) at constant NaOH concentration, only limited amount of geopolymeric gel is generated, leaving a large portion of the mine tailings particle surface un-reacted (see FIG. 7d). At the higher initial water content, however, a much larger amount of geopolymeric gel is generated, covering essentially the surface of all mine tailings particles (see FIG. 7f).

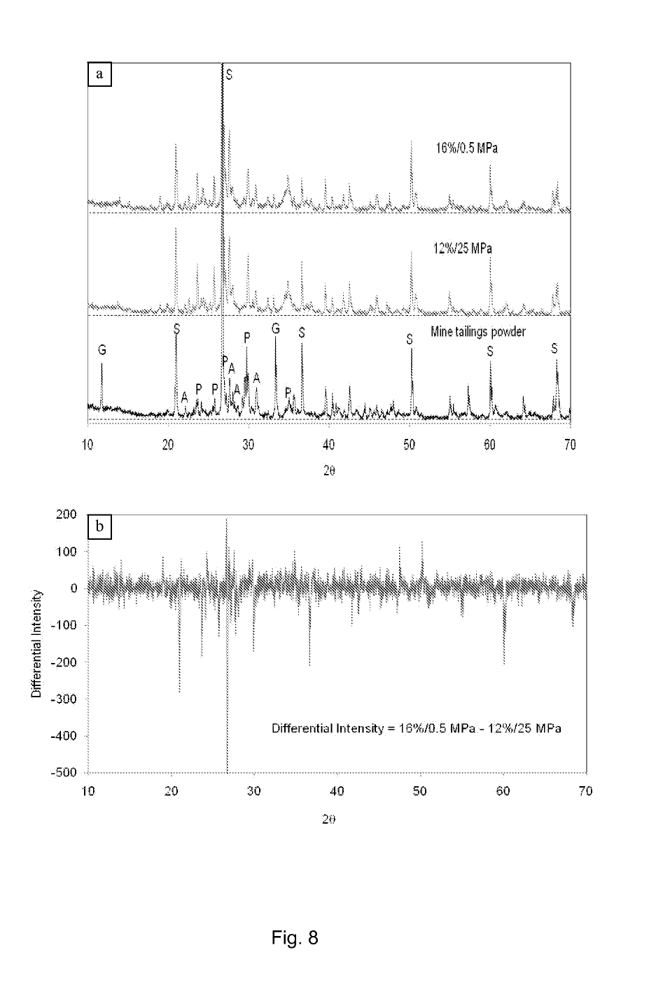

FIG. 8 shows the XRD patterns of the mine tailings powder and the two geopolymer brick specimens prepared respectively at the initial water content/forming pressure combinations of 12%/25 MPa and 16%45 MPa. The mine tailings are mainly crystalline material with a large amount of silica, which agrees with compositions shown in Table 1. After geopolymerization, although the intensity of the crystalline peaks decreases, the patterns are still crystalline. This is due to only partial dissolution of the mine tailings particles. As shown in the SEM micrographs, most particles react only on their surface and dissolve partially in the alkaline solution. The main change in the XRD patterns due to geopolymerization is the reduction in the crystalline peaks indicating the partial dissolution and formation of the amorphous and semi-crystalline phases as shown in FIG. 8.

The crystalline peak corresponding to gypsum does not appear after geopolymerization. It might have been encapsulated or incorporated in the geopolymeric gel. The amorphous phase in the original MT is a weak broad hump, which extends from about 22° to 32°. After geopolymerization, the broad hump, which is also superimposed with less intense crystalline peaks, covers a wider range from 22 to 38°. The broad hump is slightly higher for the 16%/0.5 MPa specimen indicating formation of more geopolymer gel. Another change in the XRD patterns is the transition of the sharp crystalline peaks at 26.70° and 34.82° to less featured broad humps. They do not match with any type of zeolitic materials. According to [46], zeolite is more likely to form at high water contents. FIG. 8b shows the difference between the intensities of the 16%/0.5 MPa specimen and those of the 12%/25 MPa specimen. A negative value means that the intensity at 16%/0.5 MPa is lower than that at 12%/25 MPa. The large negative peaks indicate that more crystalline silica is dissolved in the 16%/0.5 MPa specimen than in the 12%/25 MPa specimen, which agrees with the SEM micrographs that show the generation of more geopolymer gel in the 16%/0.5 MPa specimen.

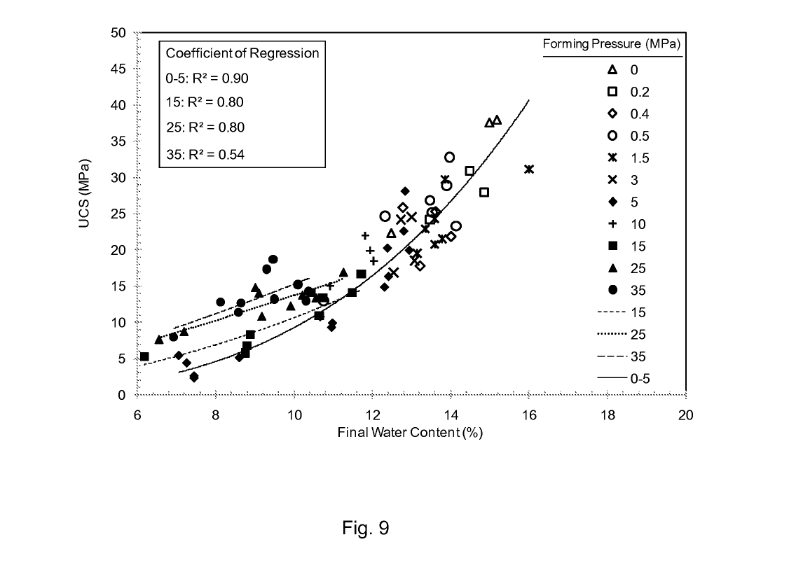

Due to the water loss during the molding process, the initial water content cannot represent the true one during geopolymerization. Therefore, we determined the final water content based on the weights of the molded specimen before and after curing. FIG. 9 shows the variation of UCS with the final water content at different forming pressures. As expected, UCS increases with both the forming pressure and the final water content. Increasing the forming pressure physically improves the granular matrix by decreasing the volume of voids and forcing the particles to be closer to each other while increasing the final water content, which means larger amount of NaOH (or larger NaOH/MT ratio) at constant NaOH concentration, chemically improves the microstructure by generating larger amount of geopolymeric gel providing a stronger bond between the particles. The effect of the final water content is much greater than that of the forming pressure in increasing the UCS, particularly when the forming pressure is low. This can be seen in FIG. 9 that a single trend line is fitted well to all of the data points corresponding to the forming pressures of 0 to 5 MPa.

The limited improving effect of the forming pressure has been observed by other researchers as well [4,21]. Freidin[21] tested fly ash-based geopolymer bricks formed with a pressure up to 20 MPa. The results indicated that the rate of increase in UCS with the forming pressure decreases as the forming pressure is higher.

### 3.2. Water Absorption

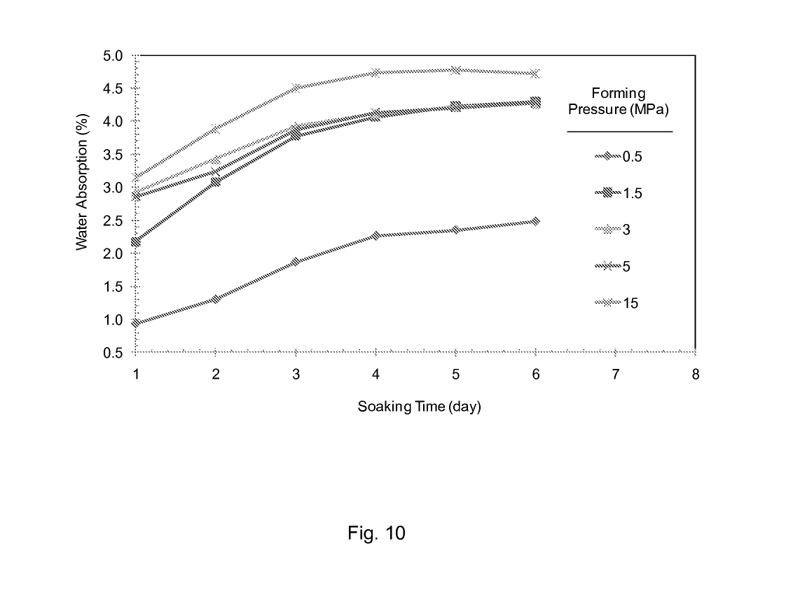

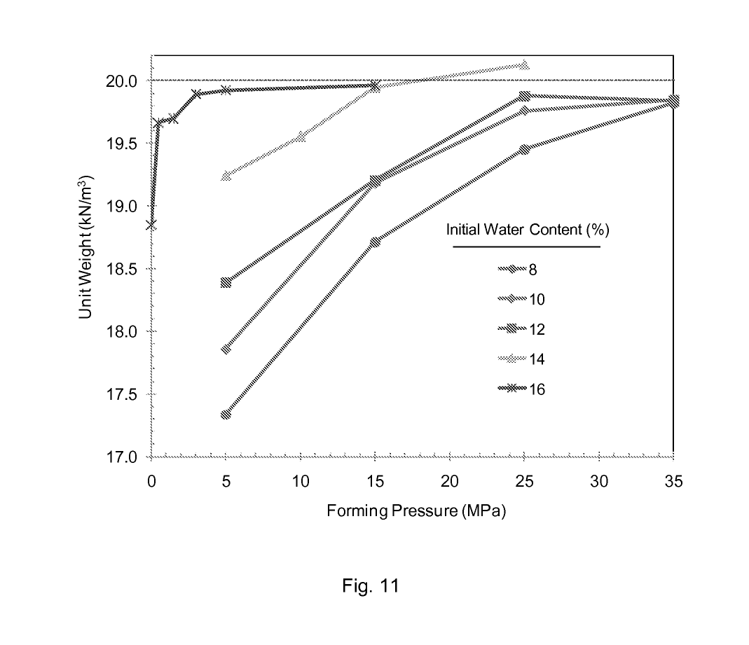

Water absorption is an important parameter for bricks. It indicates the permeability of bricks and shows the degree of reaction for fired bricks. This is also true for geopolymer bricks because higher degree of geopolymerization results in a less porous and permeable matrix. FIG. 10 shows the results of water absorption tests on the specimens prepared at 16% initial water content and different forming pressures and cured at 90° C. for 7 days. The water absorption increases with the time of soaking, the rate of increase becoming lower as the time of soaking increases. After 4 days, the change in water absorption is essentially negligible. The water absorption after 4 days' soaking varies from 2.26 to 4.73% corresponding to forming pressure from 0.5 to 15 MPa. Freidin [21] showed that for fly ash-based geopolymer bricks without hydrophobic additives, the water absorption reached its ultimate value, about 25%, within just 1 day. He also showed that the addition of hydrophobic agent decreased the ultimate water absorption to less than 10%, which was reached after about one week.

The underlying mechanism responsible for the effects of the initial water content and the forming pressure on UCS also explains the effect of the forming pressure on the water absorption as shown in FIG. 10. At a lower forming pressure, the final water content and thus the NaOH amount (or NaOH/MT ratio) are higher and a larger amount of geopolymeric gel is generated, leading to lower porosity and permeability. As the forming pressure increases, although the particles are compacted tighter to each other, less amount of geopolymeric gel is generated due to water and thus NaOH loss, leading to higher porosity and permeability.

### 3.3. Bulk Unit Weight

FIG. 11 shows the variation of the bulk unit weight with the forming pressure for geopolymer brick specimens prepared at 15 M NaOH concentration and different initial water contents and cured at 90° C. for 7 days. As expected, the unit weight increases with both the initial water content and the forming pressure. The increase of the unit weight with the initial water content is simply due to the larger amount of NaOH. The unit weight increases with the forming pressure up to a certain level and then the rate of increase drops. This is possibly because of the loss of water and thus NaOH beyond these levels of forming pressure. These levels of forming pressures are close to the forming pressures corresponding to the maximum UCS's as shown in FIG. 5.

### 3.4. ASTM Standards

Since no specification is available for geopolymer bricks, the ASTM specifications for different types of bricks are used here to evaluate the quality of the mine tailings-based geopolymer brick specimens. Table 3 summarizes the minimum compressive strengths, the maximum water absorptions, and the maximum abrasion indices required for different types of bricks [47-51].

TABLE 3
ASTM specifications for different applications of bricks.

| | | | | Maximum | | |
|---|---|---|---|---|---|---|
| | | | Minimum | water | | |
| | ASTM | | UCS | absorption | | |
| Title of specification | Designation | Type/Grade | (MPa) | (%) | Abrasion Index | |
| Structural clay load | C34-03 | LBX^{A} | 9.6^{C} | 16^{E} | NA | |
| bearing wall the | | LBX | 4.8^{D} | 16^{E} | NA | |
| | | LB^{B} | 6.8^{C} | 25^{E} | NA | |
| | | LB | 4.8^{D} | 25^{E} | NA | |
| Building brick | C62-10 | SW^{F} | 20.7 | 17 | NA | |
| | | MW^{G} | 17.2 | 22 | NA | |
| | | NW^{H} | 10.3 | No limit | NA | |
| Solid masonry unit | C126-99 | Vertical | 20.7 | NA | NA | |
| | | coring | | | | |
| | | Horizontal | 13.8 | NA | NA | |
| | | coring | | | | |
| Facing brick | C216-07a | SW | 20.7 | 17^{I} | NA | |
| | | MW | 17.2 | 22^{I} | NA | |
| Pedestrian and light | C902-07 | SX | 55.2 | 8 | Type I^{J} | 0.11 |
| traffic paving brick | | MX | 20.7 | 14 | Type II^{J} | 0.25 |
| | | NX | 20.7 | No limit | Type III^{J} | 0.50 |

Notes:
^{A}LBX = load bearing exposed;
^{B}LB = load bearing non-exposed;
^{C}end construction use;
^{D}side construction use;
^{E}based on 1 hour boiling water absorption;
^{F}severe weathering;
^{G}moderate weathering;
^{H}negligible weathering;
^{I}based on 5 hour boiling water absorption; and
^{J}Type I, II, and III are respectively subjected to extensive, intermediate,and low abrasion.

The minimum compressive strength required by the ASTM standards varies from 4.8 to 55.2 MPa depending on the application of the bricks. The compressive strength of the geopolymer brick specimens in the current study varies from 3.69 to 33.7 MPa depending on the NaOH concentration, initial water content, forming pressure and curing temperature. By selecting appropriate preparation conditions, a geopolymer brick can be produced to meet all the ASTM strength requirements except for the SX grade pedestrian and light traffic paving bricks, which requires at least 55.2 MPa.

For example, to prepare a building brick with a minimum strength of 20.7 MPa at severe weathering condition, a 15 NaOH concentration, an initial water content/forming pressure combination of 16%/0.5 MPa, and 90° C. curing temperature can be selected.

Water absorption tests were conducted only on the 16% initial water content specimens. The 24-hour water absorption varies from 0.5% to 3.45% depending on the forming pressure, which are far below the ASTM limits.

In addition to the compressive strength and the water absorption, ASTM C902-07 requires pedestrian and light traffic paving bricks to be abrasion resistant. To evaluate the abrasion resistance, an abrasion index can be determined:

$$Abrasion Index = \frac{100 \times absorption ( \% )}{U C S ( psi )} \qquad ( 2 )$$

The calculated abrasion indices for the 16% initial water content specimens are shown in Table 4 below. They are below the maximum limits shown in Table 3 (above) indicating that the produced geopolymer bricks are resistant to extensive abrasion.

TABLE 4
Abrasion indices for geopolymer brick specimens prepared at 16% initial
content and cured at 90° C. for 7 days.

| Forming pressure | UCS | 24 hour water | |
|---|---|---|---|
| (MPa) | (MPa)/(psi) | absorption (%) | Abrasion Index |
| 0.5 | 28/4,040 | 0.93 | 0.02 |
| 1.5 | 25/3,591 | 2.18 | 0.06 |
| 3.0 | 22/3,250 | 2.92 | 0.09 |
| 5.0 | 21/3,086 | 3.45 | 0.11 |
| 15.0 | 21/3,059 | 3.15 | 0.10 |

### 2. Summary and Conclusions

The feasibility of using copper mine tailings to produce geopolymer bricks was studied by conducting unconfined compression tests, water absorption tests, SEM imaging, and XRD analysis. The study investigated the effect of four major factors, NaOH concentration, initial water content, forming pressure, and curing temperature, on the physical and mechanical properties, composition, and microstructure of the produced geopolymer brick specimens. Based on the experimental results, the following conclusions can be drawn.
a) The geopolymer brick specimens prepared at 15 M NaOH concentration have higher UCS than those at 10 M. This is because higher NaOH concentration provides larger amount of NaOH at a certain initial water content required for the geopolymerization.
b) Higher initial water content means larger amount of NaOH at a constant NaOH concentration and thus increases the strength of the geopolymer brick specimens.
c) Higher forming pressure leads to larger degree of compaction and thus higher UCS if no water is squeezed out during the molding process. When the forming pressure is too high, some water and thus NaOH will be lost and the UCS will decrease.
d) Curing temperature is an important factor affecting the geopolymerization and thus the strength of geopolymer brick specimens. The UCS increases with the curing temperature up to a certain level and then decreases with the curing temperature. For the copper mine tailings studied herein, the optimum curing temperature is around 90° C.
e) By selecting appropriate preparation conditions (NaOH concentration, initial water content, forming pressure, and curing temperature), eco-friendly geopolymer bricks can be produced from the copper mine tailings to meet the ASTM requirements.

### REFERENCES

[1] Grahl C. Brick market overview: Steady growth continues in the brick industry. Ceramic Industry 2004; October Issue.
[2] The Brick Industry Association. Overview of the American Brick Industry. http://www.gobrick.com/Resources/AmericanBrickIndustry/tabid/7644/Default.aspx.
[3] China Economic Trade Committee. Tenth five-year program of building materials industry. China Building Materials 2001; 7:7-10.
[4] Chen Y, Zhang Y, Chen T, Zhao Y, Bao S. Preparation of eco-friendly construction bricks from hematite tailings. Construction and Building Materials 2011; 25:2107-11.
[5] Chou M I, Chou S F, Patel V, Pickering M D, Stucki J W. Manufacturing fired bricks with class F fly ash from Illinois Basin Coals. Combustion Byproduct Recycling Consortium, Project Number 02-CBRC-M12, Final Report; 2006.
[6] Morchhale R K, Ramakrishnan N, Dindorkar N. Utilization of copper mine tailings in production of bricks. Journal of the Institution of Engineers, Indian Civil Engineering Division 2006; 87:13-6.
[7] Roy S, Adhikari G R, Gupta, R N. Use of gold mill tailings in making bricks: a feasibility study. Waste management & Research 2007; 25; 475-82.
[8] Liu Z, Chen Q, Xie X, Xue G, Du F, Ning Q, Huang L. Utilization of the sludge derived from dyestuff-making wastewater coagulation for unfired bricks. Construction and Building Materials 2011; 25(4):1699-706.
[9] Algin H M, Turgut P. Cotton and limestone powder wastes as brick material. Construction and Building Materials 2008; 22(6):1074-80.
[10] Shon C S, Saylak D, Zollinger D G. Potential use of stockpiled circulating fluidized bed combustion ashes in manufacturing compressed earth bricks. Construction and Building Materials 2009; 23(5):2062-71.
[11] Majidi B. Geopolymer technology, from fundamentals to advanced applications: a review. Materials Technology 2009; 24(2):79-87.
[12] Van Deventer J S J, Provis J, Duxson P, Lukey G C. Technological environmental and commercial drivers for the use of geopolymers in a sustainable material industry. International Symposium of Advanced Processing of Metals and Materials; 2006. p. 241-52.
[13] Duxson P, Mallicoat S W, Lukey G C, Kriven W M, Van Deventer J S J. The effect of alkali and Si/Al ratio on the development of mechanical properties of metakaolin-based geopolymers. Colloids and Surfaces A: Physicochemical and Engineering Aspects 2007; 292(1):8-20.
[14] Dimas D, Giannopoulou I, Panias D. Polymerization in sodium silicate solutions: a fundamental process in geopolymerization technology. Journal of Materials Science 2009; 44:3719-30.
[15] Davidovits J. Mineral polymers and methods of making them. U.S. Pat. No. 4,349,386; 14 Sep. 1982.
[16] Davidovits J. Geopolymers: inorganic polymeric new materials. Journal of Thermal Analysis 1991; 37(8): 1633-56.
[17] Palomo A, Grutzeck M W, Blanco M T. Alkali-activated fly ashes A cement for the future. Cement and Concrete Research 1999; 29(18):1323-29.
[18] Li Z, Ding Z, Zhang Y. Development of sustainable cementitious materials. Proceedings of International Workshop on Sustainable Development and Concrete Technology, Beijing, China; 2004. p. 55-76.
[19] Drechsler M, Graham A. Innovative material technologies: bringing resources sustainability to construction and mining industries. 48th Institute of Quarrying Conference, Adelide S A, Australia; 2005.
[20] Shi C, Fernandez-Jimenez A. Stabilization/solidification of hazardous and radioactive wastes with alkali-activated cements. Journal of Hazardous Materials 2006; 137(3):1656-63.
[21] Freidin C. Cementless pressed blocks from waste products of coal-firing power station. Construction and Building Materials 2007; 21:12-18.
[22] Diop M B, Grutzeck M W. Low temperature process to create brick. Construction and Building Materials 2008; 22(6):1114-21.
[23] Mohsen Q, Mostafa N Y. Investigating the possibility of utilizing low kaolinitic clays in production of geopolymer bricks. Ceramics—Silikaty 2010; 54(2):160-8.
[24] Sultan H A. Stabilized copper mill tailings for highway construction. Transportation Research Record; 1979. p. 1-7.
[25] EPA (Environmental Prtotection Agency). Copper mining and production wastes. http://www.epa.gov/radiation/tenorm/copper.html.
[26] FHWA (Federal Highway Administration). User Guidelines for Byproduct and Secondary Use Materials in Pavement Construction. Report No. FHWA-RD-97-148; 2008.
[27] Pacheco-Torgal F, Castro-Gomes J P, Jalali S. Investigations on mix design of tungsten mine waste geopolymeric binder. Construction and Building Materials 2008; 22(9):1939-49.
[28] Pacheco-Torgal F, Castro-Gomes J P, Jalali S. Properties of tungsten mine waste geopolymeric binder. Construction and Building Materials 2008; 22:1201-11.
[29] Pacheco-Torgal F, Jalali S Influence of sodium carbonate addition on the thermal reactivity of tungsten mine waste mud based binders. Construction and Building Materials 2010; 24:56-60.
[30] Zhang L, Ahmari S, Zhang S. Synthesis and characterization of fly ash modified mine tailings-based geopolymers. Construction and Building Materials 2011; 25(9):3773-81.
[31] ASTM Standard C67-07a. Standard test methods for sampling and testing brick and structural clay tile. ASTM International, West Conshohocken, Pa., 2007, DOI: 10.1520/C0067-07, www.astm.org.
[32] Muñiz-Villarreal M S, Manzano-Ramirez A, Sampieri-Bulbarela S, Gasca-Tirado J R, Reyes-Araiza J L, Rubio-Avalos J C, Perez-Bueno J J, Apatiga L M, Zaldivar-Cadena A, Amigó-Borrás V. The effect of temperature on the geopolymerization process of a metakaolin-based geopolymer. Materials Letters 2011; 65(6):995-8.
[33] Yao X, Zhang Z, Zhua H, Chen Y. Geopolymerization process of alkali-metakaolinite characterized by isothermal calorimetry. Thermochimica Acta 2009; 493(1-2):49-54.
[34] Arioz O, Kilinc K, Tuncan M, Tuncan A, Kavas T. Physical, mechanical and micro-structural properties of F type fly-ash based geopolymeric bricks produced by pressure forming process. Advances in Science and Technology 2010; 69:69-74.
[35] Rattanasak U, Chindaprasirt P Influence of NaOH solution on the synthesis of fly ash geopolymer. Mineral Engineering 2009; 22:1073-78.
[36] Somna K, Jaturapitakkul C, Kajitvichyanukul P, Chindaprasirt P. NaOH-activated ground fly ash geopolymer cured at ambient temperature. Fuel 2011; 90(6):2118-24.
[37] Wang H, Li H, Yan F. Synthesis and mechanical properties of metakaolinite-based geopolymer. Colloids and Surfaces A: Physicochemical and Engineering Aspects 2005; 268(1-3):1-6.
[38] Khale D, Chaudhary R. Mechanism of geopolymerization and factors influencing its development: a review. Journal of Materials Science 2007; 42:729-46.
[39] Steveson M, Sagoe-Crentsil K. Relationships between composition, structure and strength of inorganic polymers, Part I Metakaolin-derived inorganic polymers. Journal of Materials Science 2005; 40:2023-36.
[40] De Silva P, Sagoe-Crenstil K, Sirivivatnanon V. Kinetics of geopolymerization: Role of Al₂O₃ and SiO₂. Cement and Concrete Research; 2007; 37(4):512-8.
[41] Rowles M, O'Connor B. Chemical optimisation of the compressive strength of aluminosilicate geopolymers synthesised by sodium silicate activation of metakaolinite. Journal of Materials Chemistry 2003; 13(5):1161-5.
[42] Tippayasam C, Boonsalee S, Sajjavanich S, Ponzoni C, Kamseu E, Chaysuwan D. Geopolymer development by powders of metakaolin and wastes in Thailand. Advances in Science and Technology 2010; 69:63-8.
[43] Zivica V, Balkovic S, Drabik M. Properties of metakaolin geopolymer hardened paste prepared by high-pressure compaction. Construction and Building Materials 2011; 25(5):2206-13.
[44] Majkrzak II G L, Watson J P, Bryant M M, Clayton K. Effect of cenospheres on fly ash brick properties. World of Coal Ash (WOCA), Kentucky; 2007.
[45] Liu H, Van Engelenhoven J. Use of ASTM standards for testing freeze-thaw resistance of fly ash bricks. World of Coal Ash (WOCA) Conference, KY, USA; 2009.
[46] Hawkings D B. Kinetics of glass dissolution and zeolite formation under hydrothermal conditions. Clays and Clay Minerals 1981; 29(5):331-40.
[47] ASTM Standard C34-03. Standard specification for structural clay load-bearing wall tile.
ASTM International, West Conshohocken, Pa., 2003, DOI: 10.1520/C0034-03, www.astm.org.
[48] ASTM Standard C62-10. Standard specification for building brick (solid masonry units made from clay or shale). ASTM International, West Conshohocken, Pa., 2010, DOI: 10.1520/C0062-10, www.astm.org.
[49] ASTM Standard C126-99. Standard specification for ceramic glazed structural clay facing tile, facing brick, and solid masonry units. ASTM International, West Conshohocken, Pa., 1999, DOI: 10.1520/C0126-99, www.astm.org.
[50] ASTM Standard C216-07a. Standard specification for facing brick (solid masonry units made from clay or shale). ASTM International, West Conshohocken, Pa., 2007, DOI: 10.1520/C0216-07A, www.astm.org.
[51] ASTM Standard C902-07. Standard specification for pedestrian and light traffic paving brick. ASTM International, West Conshohocken, Pa., 2007, DOI:10.1520/C0902-07, www.astm.org.

What is claimed is:

1. A method for forming bricks from copper mine waste tailings, comprising the steps of:
mixing a predetermined amount of copper mine tailings with a sodium hydroxide solution until a homogenous mixture with a consistency from semi-dry to semi-paste is formed;
compressing said homogenous mixture in a mold at a predetermined forming pressure to form a brick; and
curing said brick at a predetermined temperature.

2. The method of claim 1, wherein said predetermined amount is determined based on the concentration of the NaOH solution and the weight percentage of water relative to said copper mine tailings.

3. The method of claim 2, wherein said sodium hydroxide solution is between about 10M and 15M.

4. The method of claim 1, wherein said forming pressure is from about 0 to 35 MPa.

5. The method of claim 1, wherein said temperature ranges from about 60° C. to 120° C.

6. The method of claim 1, wherein said copper mine tailings have an initial water content from 8 to 18%.

7. The method of claim 1, wherein said copper mine tailings have a mean particle size of about 120 μm.

8. The method of claim 1, wherein said sodium hydroxide solution is 15M in concentration, an initial water content/forming pressure combination is 16%/0.5 MPa, and said temperature is 90° C.

9. The method of claim 1, wherein said curing is substantially complete in about 7 days.

10. A method for forming bricks from copper mine waste tailings, comprising the steps of:
processing copper mine tailings into a dry powder with a mean particle size of about 120 μm,
mixing a predetermined amount of a 15M sodium hydroxide solution with said dry powder until a homogenous mixture with a consistency from semi-dry to semi-paste is formed;
compressing said homogenous mixture in a mold at a predetermined forming pressure to form a brick; and
curing said brick at temperature of between 60° C.-90° C.

11. The method of claim 10, wherein said curing is substantially complete in about 7 days.

12. A method for forming bricks from mine waste tailings, comprising the steps of:
mixing a predetermined amount of mine tailings having an amount of silica and alumina to enable geopolymerization with a sodium hydroxide solution until a homogenous mixture with a consistency from semi-dry to semi-paste is formed;
compressing said homogenous mixture in a mold at a predetermined forming pressure to form a brick;
and curing said brick at a predetermined temperature.

13. The method of claim 12, wherein said predetermined amount is determined based on the concentration of the NaOH solution and the weight percentage of water relative to said mine tailings.

14. The method of claim 13, wherein said sodium hydroxide solution is between about 10M and 15M.

15. The method of claim 12, wherein said forming pressure is from about 0 to 35 MPa.

16. The method of claim 12, wherein said temperature ranges from about 60° C. to 120° C.

17. The method of claim 12, wherein said mine tailings have an initial water content from 8 to 18%.

18. The method of claim 12, wherein said mine tailings have a mean particle size of about 120 μm.

19. The method of claim 12, wherein said sodium hydroxide solution is 15M in concentration, an initial water content/forming pressure combination is 16%/0.5 MPa, and said temperature is 90° C.

20. The method of claim 12, wherein said curing is substantially complete in about 7 days.
